(19) United States
(12) Patent Application Publication
(10) Pub. No.: US 2013/0106599 A1
(43) Pub. Date: May 2, 2013

(54) VEHICLE PRESENCE NOTIFICATION APPARATUS

(71) Applicants: DENSO Corporation, Kariya-city (JP); HAMANAKODENSO CO., LTD., Kosai-city (JP)

(72) Inventors: Toshiaki NAKAYAMA, Miyoshi-city (JP); Koji SUZUKI, Hamamatsu-city (JP)

(73) Assignees: HAMANAKODENSO CO., LTD., Kosai-city (JP); DENSO Corporation, Kariya-city (JP)

(21) Appl. No.: 13/662,908

(22) Filed: Oct. 29, 2012

(30) Foreign Application Priority Data
Oct. 31, 2011 (JP) 2011-238865

(51) Int. Cl. B60Q 1/54

(52) U.S. Cl. 340/466

(57) ABSTRACT

A vehicle presence notification apparatus notifying a presence of a vehicle includes a directivity speaker and a directivity controller. The directivity speaker generates a false engine sound out of the vehicle. The directivity controller controlling a directivity of the false engine sound based on a speed of the vehicle. The directivity controller controls a ratio of a high-pitched frequency component to a low-pitched frequency component in the false engine sound based on the speed of the vehicle.

### CROSS REFERENCE TO RELATED APPLICATION

This application is based on Japanese Patent Application No. 2011-238865 filed on Oct. 31, 2011, the disclosure of which is incorporated herein by reference in its entirety.

### TECHNICAL FIELD

The present disclosure relates to a vehicle presence notification apparatus.

### BACKGROUND

In recent years, the number of electric vehicles driven by electric motor is increased. A vehicle presence notification apparatus generates a false engine sound to notify the presence of the electric vehicle. The false engine sound is required to reduce the sense of incongruity compared with a real engine sound.

The real engine sound such as engine mechanical sound or air suction noise is generated in an engine compartment of an engine vehicle driven by an engine. The real engine sound is emitted from the lower part of the engine compartment, and travels frontward through a front grille of the engine vehicle.

Furthermore, as a speed of the engine vehicle is raised, the rotation number of the engine is increased. Accordingly, as the speed is raised, the real engine sound shifts to high-pitched side, and the directivity of the real engine sound is narrowed to the frontward direction.

The vehicle presence notification apparatus is required to narrow the directivity of the false engine sound as the speed of the vehicle is raised.

It is known that the directivity becomes narrow when many speakers are arranged side by side. JP-2005-333573A describes such an art controlling the directivity of the false engine sound by changing the number of speakers emitting sound.

However, the size of the vehicle presence notification apparatus becomes large because it is necessary to carry the many speakers. In this case, the cost becomes high, and it becomes difficult to mount the vehicle presence notification apparatus to the electric vehicle.

### SUMMARY

According to an example of the present disclosure, a vehicle presence notification apparatus notifying a presence of a vehicle includes a directivity speaker and a directivity controller. The directivity speaker generates a false engine sound out of the vehicle. The directivity controller controlling a directivity of the false engine sound based on a speed of the vehicle. The directivity controller controls a ratio of a high-pitched frequency component to a low-pitched frequency component in the false engine sound based on the speed of the vehicle.

A directivity of a sound is narrowed as a frequency is raised. Therefore, the directivity of the false engine sound can be controlled in accordance with the speed of the vehicle. Thus, the false engine sound can be made realistic.

Because many speakers are not necessary, the cost can be reduced and it becomes easy to mount the vehicle presence notification apparatus which can control the directivity of the false engine sound.

The directivity controller may increase the ratio of the high-pitched frequency component to the low-pitched frequency component in the false engine sound as the speed of the vehicle is raised.

Therefore, the directivity of the false engine sound can be made similar to that of a real engine sound in accordance with the speed of the vehicle.

The false engine sound may have a sound-pressure emphasis region, and the directivity controller may change the sound-pressure emphasis region from the low-pitched frequency component to the high-pitched frequency component as the speed of the vehicle is raised.

Therefore, the directivity of the false engine sound can be made similar to that of a real engine sound in accordance with the speed of the vehicle.

### BRIEF DESCRIPTION OF THE DRAWINGS

The above and other objects, features and advantages of the present disclosure will become more apparent from the following detailed description made with reference to the accompanying drawings. In the drawings:

FIG. 1 is an explanatory view illustrating a relationship between a driving state of a vehicle, and frequency distribution and characteristics of a notification sound emitted from a vehicle presence notification apparatus according to a first embodiment;

FIG. 2 is a schematic block diagram illustrating the vehicle presence notification apparatus;

FIG. 3 is a schematic cross-sectional view illustrating the vehicle presence notification apparatus mounted in a vehicle;

FIG. 4A is a cross-sectional view illustrating the vehicle presence notification apparatus, and FIG. 4B is a perspective view illustrating the vehicle presence notification apparatus;

FIG. 5 is a graph illustrating a relationship between a frequency and a sound pressure level to explain frequency characteristic of a vehicular horn of the vehicle presence notification apparatus in cases of applying self excitation voltage and separate excitation voltage;

FIG. 6A is an explanatory view illustrating a sound distribution of a directivity speaker of the vehicle presence notification apparatus, and FIG. 6B is an explanatory view illustrating a sound distribution of the vehicular horn;

FIG. 7A, FIG. 7B and FIG. 7C are explanatory views illustrating a process of producing a false engine sound emitted from the vehicle presence notification apparatus;

FIG. 8A, FIG. 8B, FIG. 8C, FIG. 8D, and FIG. 8E are explanatory views illustrating a principle of the directivity speaker; and

FIG. 9 is an explanatory view illustrating a relationship between a driving state of a vehicle, and frequency distribution and characteristics of a notification sound emitted from a vehicle presence notification apparatus according to a second embodiment.

### DETAILED DESCRIPTION

Embodiments of the present disclosure will be described hereafter referring to drawings. In the embodiments, a part that corresponds to a matter described in a preceding embodiment may be assigned with the same reference numeral, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

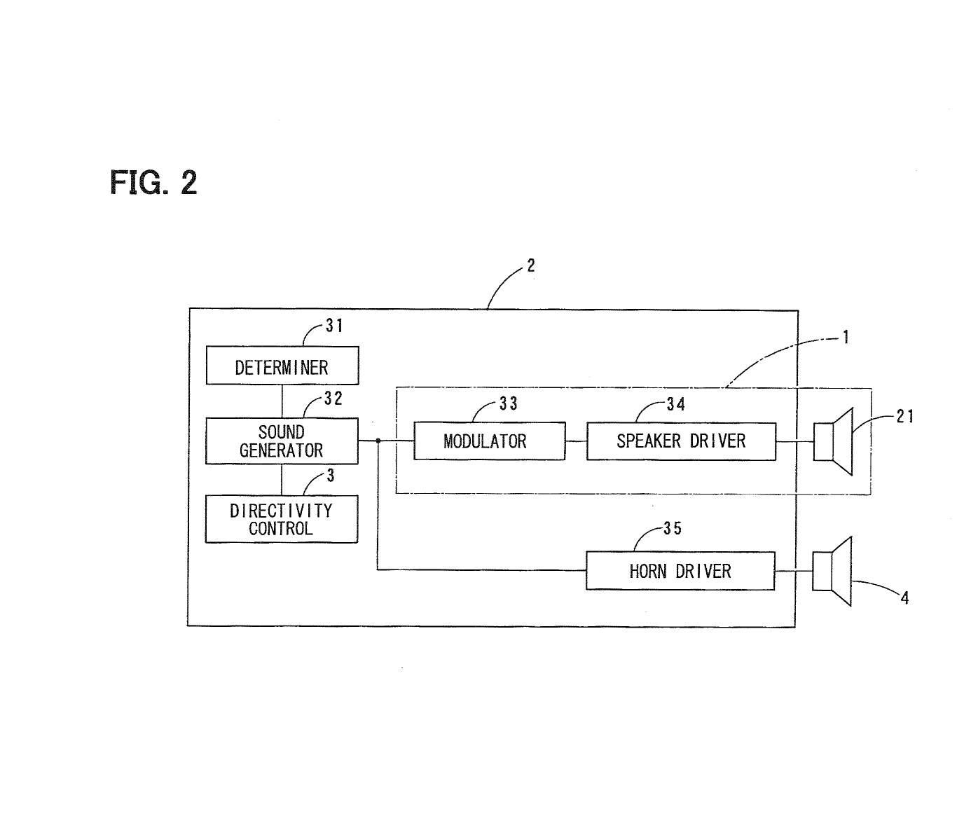

A vehicle presence notification apparatus is mounted to a vehicle, and generates a false engine sound (notification sound) out of the vehicle to notify a presence of the vehicle, for example, for a pedestrian around the vehicle when a predetermined condition is satisfied. As shown in FIG. 2, the vehicle presence notification apparatus includes a directivity speaker 1 (parametric speaker) and a control circuit 2. The directivity speaker 1 generates the false engine sound frontward from the vehicle. The control circuit 2 controls an operation of the directivity speaker 1.

The vehicle presence notification apparatus includes a directivity controller 3 which narrows the directivity of the false engine sound generated out of the vehicle as a speed of the vehicle is raised.

The directivity controller 3 changes a ratio of a high-pitched frequency component to a low-pitched frequency component in the false engine sound based on the speed of the vehicle. For example, as the speed of the vehicle is raised, the directivity controller 3 increases the ratio of the high-pitched frequency component to the low-pitched frequency component in the false engine sound.

Embodiment is an example and the present disclosure is not limited to the following embodiments.

### First Embodiment

A vehicle presence notification apparatus according to a first embodiment is used for an electric vehicle not equipped with an engine, such as electric car or fuel-cell electric car. Vehicle sound generated by the electric vehicle not equipped with an engine is small. Alternatively, the vehicle presence notification apparatus of the first embodiment is used for a hybrid car, in which an engine is suspended while the hybrid car is traveling. Vehicle sound generated by the hybrid car is small when the engine is suspended.

The vehicle presence notification apparatus generates a false engine sound (notification sound) out of the vehicle to notify a presence of the vehicle when a predetermined condition is satisfied. As shown in FIG. 2, the vehicle presence notification apparatus includes a directivity speaker 1 (parametric speaker), a vehicular horn 4 (dynamic speaker), and a control circuit 2. A directivity of a false engine sound emitted from the directivity speaker 1 is electronically controlled. The horn 4 is a non-directivity speaker generating a false engine sound. The control circuit 2 controls the directivity speaker 1 and the vehicular horn 4.

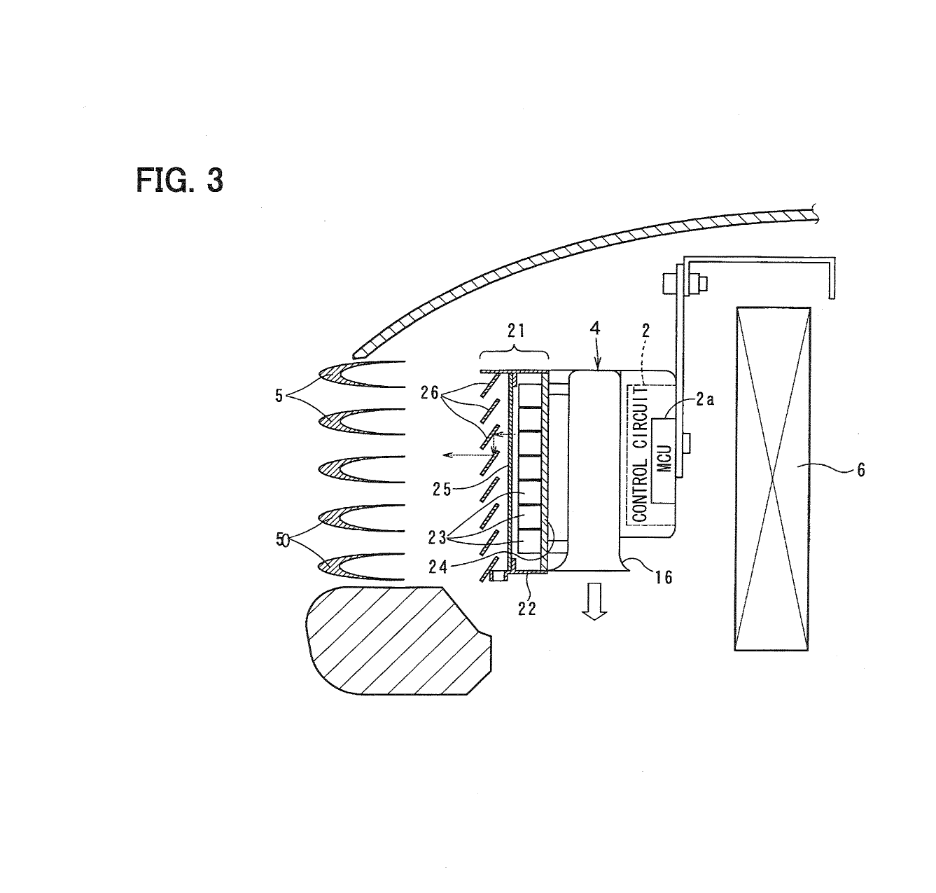

As shown in FIG. 3, the horn 4 is fixed between a front grille 5 and a heat exchanger 6 such as radiator for air-conditioning. The horn 4 is an electromagnetically-operated horn, and generates a warning sound when a driver of the vehicle operates a warning button fixed to a steering. The warning sound is generated when a self excitation voltage is provided. The self excitation voltage may be a direct-current (DC) voltage of 8V or more supplied from a battery.

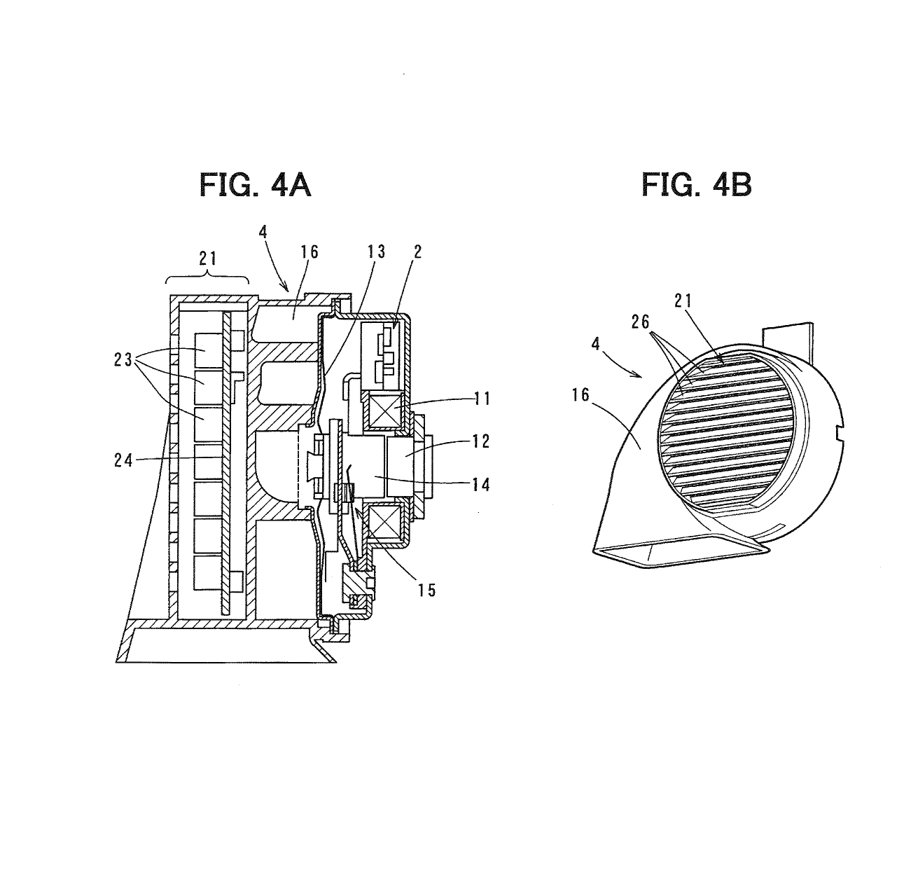

The horn 4 is described with reference to FIGS. 4A and 4B. The horn 4 includes a coil 11, a fixed iron core 12, a movable iron core 14 and a current interrupter 15. The coil 11 generates magnetic force by being supplied with electricity. The fixed iron core 12 (attraction core) generates magnetic attraction force by the magnetic force generated by the coil 11. The movable iron core 14 (movable core) is supported at the central part of a diaphragm 13 to be movable toward the fixed iron core 12. The interrupter 15 intermittently turns on an energization circuit of the coil 11 when the self excitation voltage is impressed to the coil 11.

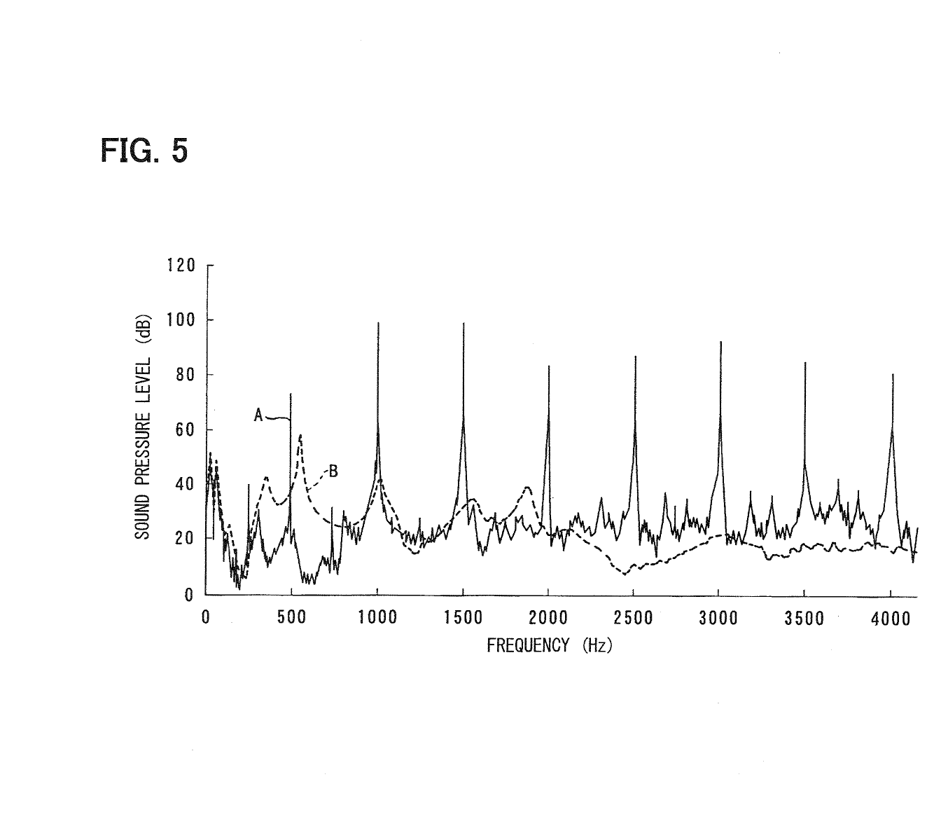

Specifically, when the self excitation voltage is applied to the horn 4, the horn 4 emits a warning sound with frequency characteristics illustrated by a continuous line A of FIG. 5.

Moreover, the horn 4 is used as a dynamic speaker when a drive signal is input, that is a separate excitation voltage less than 8V. The separate excitation voltage is lower than the self excitation voltage. That is, the horn 4 produces the warning sound when the self excitation voltage is impressed, and produces a false engine sound as a dynamic speaker when the separate excitation voltage is impressed.

The frequency characteristics of the horn 4 used as the dynamic speaker are shown in a broken line B of FIG. 5. Specifically, the broken line B represents frequency characteristics of the horn 4 when a sine-wave sweep signal of 1V is applied to the horn 4. The sweep signal represents a variable signal varied from low frequency to high frequency.

As shown in FIGS. 4A and 4B, the horn 4 is equipped with a swirl casing 16 having a spiral trumpet shape to form a spiral sound passage. The warning sound generated by vibration of the diaphragm 13 is increased by the swirl casing 16, and is emitted out of the vehicle.

The horn 4 is attached to the vehicle in a manner that an opening of the swirl casing 16 faces a road surface under the vehicle, as shown in FIG. 3. Therefore, when the frequency generated by the horn 4 is varied, the false engine sound is emitted approximately uniformly around the circumference of the vehicle.

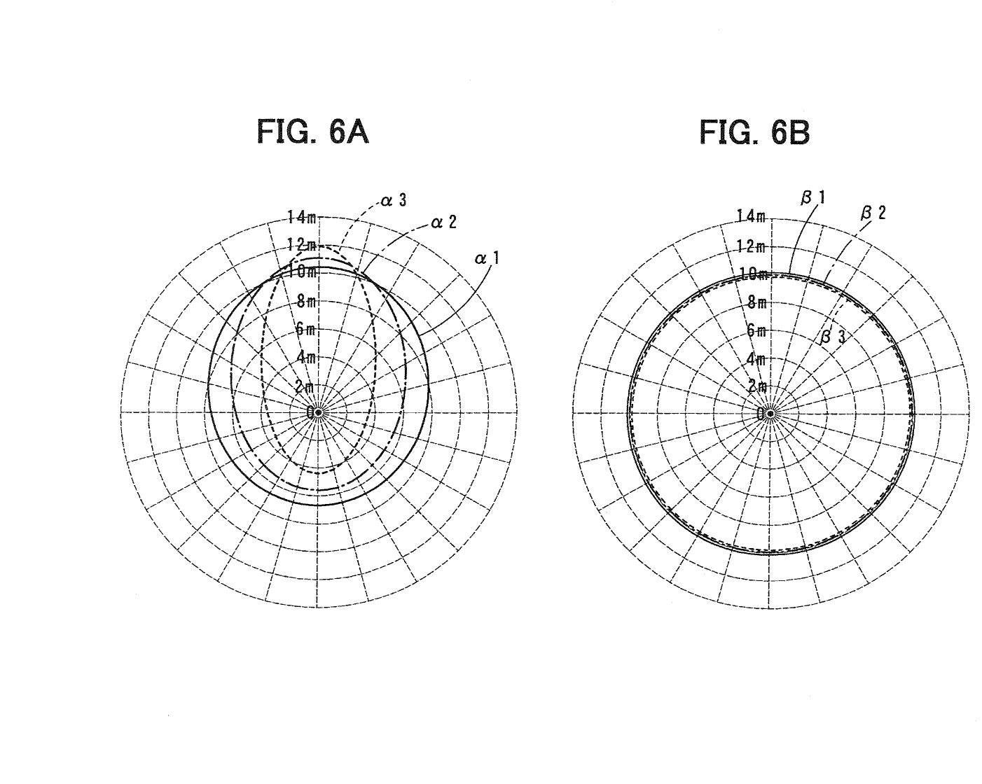

For example, a reach area of the sound generated by the horn 4 (non-directivity speaker) is described with reference to FIG. 6B.
(i) When the horn 4 generates 500 Hz sound, the sound is transmitted within an area represented by a continuous line β1 of FIG. 6B.
(ii) When the horn 4 generates 2 kHz sound, the sound is transmitted within an area represented by a single-chain line β2 of FIG. 6B.
(iii) When the horn 4 generates 4 kHz sound, the sound is transmitted within an area represented by a broken line β3 of FIG. 6B.

In addition, the reach area represented by the line β1, β2, β3 is defined in a case where the sound has a sound pressure of 50 dB.

The directivity speaker 1 modulates a waveform signal of an audible sound (false engine sound) into ultrasonic frequency, and emits the modulated ultrasonic signal from an ultrasonic speaker 21. A modulation component contained in the ultrasonic wave (not heard by an ear of human) emitted from the ultrasonic speaker 21 has a self-demodulation in the air in which the wave is traveling. Thereby, an audible sound (false engine sound) is generated at a place distant from the ultrasonic speaker 21.

The ultrasonic speaker 21 of the directivity speaker 1 is an ultrasonic wave generator generating aerial vibration with a frequency (not less than 20 kHz) higher than human audible band region, and is mounted to the vehicle so that the ultrasonic wave is emitted frontward from the vehicle.

As shown in FIG. 3, the ultrasonic speaker 21 is affixed to the swirl housing 16 of the horn 4 that is attached to the vehicle. Thus, the ultrasonic speaker 21 is arranged to emit the ultrasonic wave frontward from the vehicle.

The ultrasonic speaker 21 has a housing 22 made of resin and plural ultrasonic vibrators 23. The housing 22 may be integrated with the swirl housing 16, or may be attached to the swirl housing 16. The plural ultrasonic vibrators 23 are arranged inside of the housing 22.

The ultrasonic vibrator 23 may be made of a piezoelectric speaker having a piezoelectric element and an ultrasonic vibration plate. The piezoelectric element expands and contracts (charges and discharges) according to a voltage applied to the piezoelectric element. The ultrasonic vibration plate is driven by the expansion and the contraction of the piezoelectric element, and produces a loose-and-dense wave in the air.

The plural ultrasonic vibrators 23 are arranged on a support plate 24 which is disposed inside of the housing 22, and work as a speaker array.

The ultrasonic speaker 21 has an opening as an emission port through which the ultrasonic wave is emitted from the ultrasonic vibrator 23 frontward from the vehicle. A water preventing portion is arranged in the opening, and prevents water such as rain from invading the ultrasonic vibrator 23.

The water preventing portion includes a waterproof sheet 25 and a louver 26. Ultrasonic transmission is possible in the waterproof sheet 25 which covers the opening. The louver 26 is arranged on the front face of the waterproof sheet 25. In FIG. 4A, the waterproof sheet 25 and the louver 26 are omitted, for convenience.

The ultrasonic speaker 21 emits the ultrasonic wave ahead of the vehicle.

If a dynamic speaker such as cone speaker is mounted to face frontward instead of the directivity speaker 1, the false engine sound is emitted from the dynamic speaker frontward from the vehicle.

As the frequency is made lower, the sound (acoustic wave) becomes easy to spread. As the frequency is made higher, the directivity of the sound becomes narrow. For this reason, as the frequency is made higher, the directivity becomes narrow even in the dynamic speaker.

For example, a reach area of the sound generated by the dynamic speaker is described with reference to FIG. 6A.
(i) When the frontward-mounted dynamic speaker generates 500 Hz sound, the sound is transmitted within an area represented by a continuous line α1 of FIG. 6A.
(ii) When the frontward-mounted dynamic speaker generates 2 kHz sound, the sound is transmitted within an area represented by a single-chain line α2 of FIG. 6A.
(iii) When the frontward-mounted dynamic speaker generates 4 kHz sound, the sound is transmitted within an area represented by a broken line α3 of FIG. 6A.

In addition, the reach area represented by the line α1, α2, α3 is defined in a case where the sound has a sound pressure of 50 dB.

The directivity of the sound relative to the frequency is explained using the dynamic speaker in FIG. 6A. In the case of the false engine sound reproduced by the directivity speaker 1, the directivity of the sound is changed by a variation in the frequency, similarly to the case of the dynamic speaker.

As shown in FIG. 3, the control circuit 2 includes a microcomputer chip 2a (MCU) with a well-known structure including CPU which performs computing, a memory which stores a program, an input circuit, and an output circuit. The controlling circuit 2 may be disposed in a housing of the horn 4, or may be disposed in the vehicle separate from the horn 4.

Driving state information of the vehicle such as speed is input into the control circuit 2 from an engine control unit (ECU). The control circuit 2 is energized from a power source. When a predetermined condition is satisfied to notify a presence of the vehicle, the control circuit 2 drives the ultrasonic speaker 21 and the vehicular horn 4 to generate a false engine sound out of the vehicle.

As shown in FIG. 2, the control circuit 2 has a determiner 31, a sound generator 32, a modulator 33, a speaker driver 34, a horn driver 35, and a directivity controller 3. The determiner 31 determines whether the operational status of the vehicle meets the predetermined condition of generating the false engine sound. The sound generator 32 generates a signal instructing the false engine sound according to the driving condition of the vehicle (drive in reverse, stop, or move ahead), so as to generate a notification sound. The modulator 33 modulates the signal output from the sound generator 32 into ultrasonic frequency. The speaker driver 34 is an amplifier which drives the ultrasonic speaker 21 by the ultrasonic-modulated signal output from the modulator 33. The horn driver 35 is an amplifier which drives the horn 4 by the signal output from the sound generator 32. The directivity controller 3 changes the directivity of the false engine sound emitted ahead of the vehicle from the directivity speaker 1, according to the speed of the vehicle.

The determiner 31 determines whether the operational status of the vehicle meets the predetermined condition of generating the false engine sound, for example, when a driving switch of the vehicle is turned on and when the speed of the vehicle is lower than or equal to a predetermined speed such as 20 km/h. When the operational status of the vehicle meets the predetermined condition, the determiner 31 drives the sound generator 32.

The sound generator 32 may be constructed by a sound generating program (sound software), and produces the signal instructing the false engine sound using a digital technology, when the instruction signal is provided from the determiner 31.

Specifically, the sound generator 32 is configured to generate
(i) a signal instructing intermittent warning sound while the vehicle drives in reverse (when the gear of the vehicle is set in a reverse range), and
(ii) a false engine sound corresponding to the speed of the vehicle while the vehicle is stopped or driving (when the gear is set in a park range or a drive range).

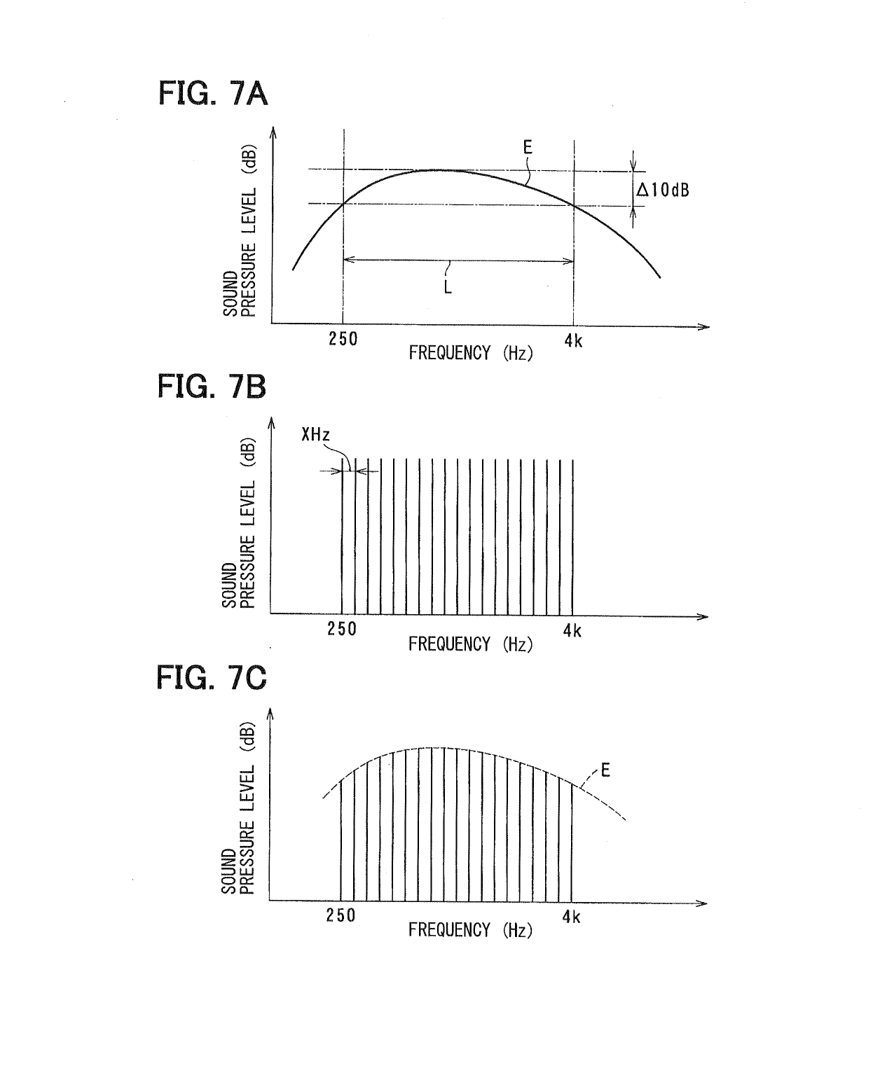

The sound generator 32 creates a frequency signal (waveform signal) to produce the false engine sound based on a clock signal generated by a reference quartz oscillator of the microcomputer chip 2a. Specifically, as shown in FIG. 7B, the sound generator 32 simultaneously generates a large number of the frequency signals continuous at a predetermined frequency interval XHz (for example, 4 Hz-32 Hz) as a roar frequency. The roar frequency may be fixed or may be changed according to the operational status of the vehicle such as speed.

As shown in FIG. 7A, the sound generator 32 has a frequency range specifying portion (program), that generates the large number of the frequency signals within a predetermined frequency band L corresponding to a generation area of the false engine sound.

Furthermore, as shown in FIG. 7C, the sound generator 32 has a frequency characteristics processor (program), that processes (characterizes) frequency characteristics E relative to the large number of the frequency signals.

The large number of the frequency signals represent the signal instructing the false engine sound.

The modulator 33 modulates the output (signal instructing the false engine sound) of the sound generator 32 into the ultrasonic frequency.

Specifically, the modulator 33 conducts an amplitude modulation (AM), that is, the modulator 33 modulates the output signal of the sound generator 32 into an amplitude variation (increase and decrease in the voltage) in a predetermined ultrasonic frequency (for example, 25 kHz).

The modulator 33 is not limited to conduct the amplitude modulation. Other ultrasonic modulation technology may be used such as pulse width modulation (PWM) which modulates the output signal of the sound generator 32 into a pulse width variation (time period between pulses) in a predetermined ultrasonic frequency.

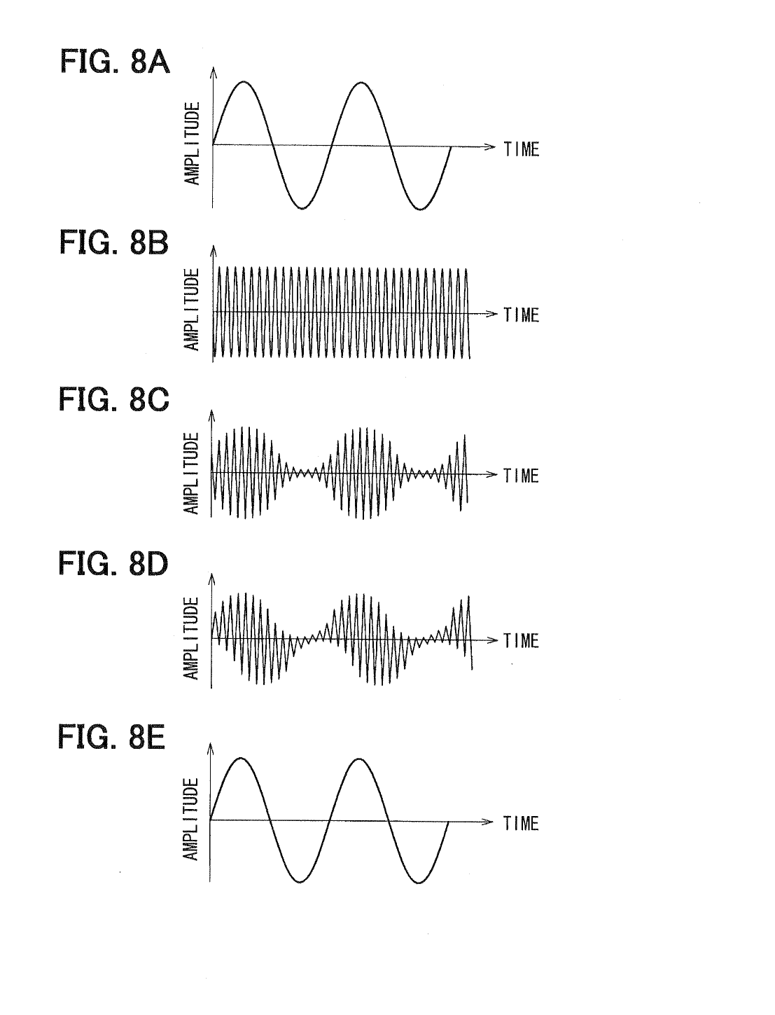

An example of the ultrasonic modulation conducted by the modulator 33 is explained with reference to FIGS. 8A-8E. For example, the signal instructing the false engine sound (false idling sound or false driving sound) input into the modulator 33 is defined to have a voltage variation shown in FIG. 8A. In addition, a single frequency waveform is shown in FIG. 8A, for easy understanding. On the other hand, the ultrasonic oscillator of the control circuit 2 oscillates with the ultrasonic frequency shown in FIG. 8B.

As shown in FIG. 8C, the modulator 33 increases the amplitude of the voltage of the ultrasonic oscillation, as the voltage of the signal instructing the false engine sound of FIG. 8A becomes large. Further, the modulator 33 decreases the amplitude of the voltage of the ultrasonic oscillation, as the voltage of the signal instructing the false engine sound of FIG. 8A becomes small. Thus, the modulator 33 modulates the signal instructing the false engine sound of FIG. 8A output from the sound generator 32 into the amplitude variation in the voltage of the ultrasonic frequency of FIG. 8C. FIG. 8C illustrates the ultrasonic signal obtained by modulating the amplitude.

The speaker driver 34 is an amplifier driving the ultrasonic speaker 21 based on the ultrasonic signal modulated by the modulator 33. The speaker driver 34 causes the ultrasonic vibrator 23 to generate the ultrasonic wave defined by modulating the signal instructing the false engine sound by controlling the voltage applied to the ultrasonic vibrator 23. That is, the speaker driver 34 controls the charge-and-discharge state of the ultrasonic vibrator 23.

The horn driver 35 is a power amplifier activating the horn 4 as a dynamic speaker, and amplifies the signal instructing the false engine sound output from the sound generator 32. The horn driver 35 inputs the amplified signal into an energization terminal of the horn 4.

In addition, when the false engine sound is emitted from the horn 4, the horn driver 35 controls the energization of the coil 11 of the horn 4 in a manner that the horn 4 does not generate a warning sound (namely, in a manner that the interrupter 15 is restricted from operating).

In addition, the control circuit 2 may have a sound-pressure variable portion that varies the sound pressure of the false engine sound emitted from the directivity speaker 1 based on the speed of the vehicle. The sound-pressure variable portion raises the sound pressure of the false engine sound reproduced by the directivity speaker 1 as the speed of the vehicle is raised. The sound-pressure variable portion varies the amplification gain of the speaker driver 34.

Specifically, the sound-pressure variable portion may vary the voltage supplied to the speaker driver 34 based on the speed, or may vary the signal voltage of the speaker driver 34 before the last amplification. Further, the sound-pressure variable portion may change the number of the ultrasonic vibrators 23 in use. Moreover, the variation of the amplification gain performed by the sound-pressure variable portion may be stepwise variation or continuous variation.

In addition, the sound-pressure variable portion may raise the sound pressure of the false engine sound based on not only the speed but also the driving state of the vehicle under rainy or snow weather.

The directivity controller 3 narrows the directivity of the false engine sound emitted frontward from the vehicle as the speed of the vehicle is raised.

The directivity controller 3 changes a ratio of a high-pitched frequency component to a low-pitched frequency component in the frequency signal instructing the false engine sound, based on the speed of the vehicle.

Specifically, the directivity controller 3 processes the frequency characteristics of the false engine sound according to the speed using the frequency-characteristics processor of the sound generator 32. As the speed is raised, the ratio of the high-pitched frequency component to the low-pitched frequency component in the false engine sound is continuously (or stepwise) increased.

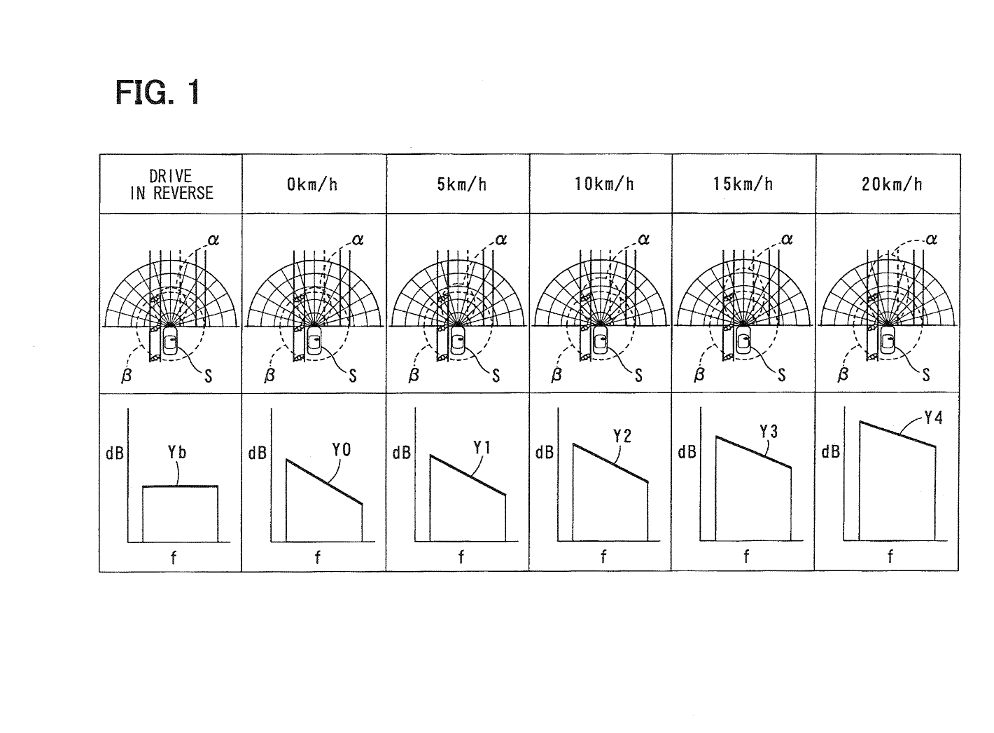

Operation of the directivity controller 3 will be specifically described with reference to FIG. 1.
(i) When the speed of the vehicle S is 0 km/h (when the vehicle S is stopped), to express the false engine sound at the time of idling, the frequency characteristics Y0 is set in which the low-pitched frequency component is increased.
(ii) When the speed is 5 km/h, the frequency characteristics Y1 is set in which the high-pitched frequency component is slightly increased compared with the above case where the vehicle is stopped.
(iii) When the speed is 10 km/h, the frequency characteristics Y2 is set in which the high-pitched frequency component is slightly increased compared with the above case where the speed is 5 km/h.
(iv) When the speed is 15 km/h, the frequency characteristics Y3 is set in which the high-pitched frequency component is slightly increased compared with the above case where the speed is 10 km/h.
(v) When the speed is 20 km/h, the frequency characteristics Y4 is set in which the high-pitched frequency component is slightly increased compared with the above case where the speed is 15 km/h.

In addition, when the vehicle S drives in reverse (when the gear is set in the reverse range), to express the retreat signal, the frequency characteristics Yb is set in which the high-pitched frequency component is increased to be approximately the same as the low-pitched frequency component, compared with the above case where the vehicle is stopped.

Operation of the vehicle presence notification apparatus will be described. When the determiner 31 determines that the operational status of the vehicle meets the condition of generating the false engine sound, the sound generator 32 outputs the signal instructing the false engine sound according to the operational status of the vehicle.

The ultrasonic speaker 21 emits the ultrasonic wave of FIG. 8C, (acoustic wave which cannot be heard by human), which is produced by modulating the signal instructing the false engine sound, frontward from the vehicle. Then, as shown in FIG. 8D, while the ultrasonic wave travels in the air, the ultrasonic wave with a short wave length is distorted by the viscosity of air.

As a result, as shown in FIG. 8E, the amplitude component contained in the ultrasonic wave traveling in the air has self-demodulation. Therefore, the false engine sound is reproduced at a place frontward distanced from the vehicle, from which the ultrasonic wave is emitted through the ultrasonic speaker 21 as an ultrasonic wave source.

As shown in FIG. 1, the reach area a of the false engine sound emitted from the directivity speaker 1 is increased as the speed of the vehicle is raised. In FIG. 1, the vehicle presence notification apparatus is mounted to the subject vehicle S, and the broken line α represents the reach area of the false engine sound with the sound pressure of 50 dB.

On the other hand, the false engine sound is directly produced according to the operational status of the vehicles to the circumference of the vehicle from the horn 4 when the sound generator 32 outputs the signal instructing the false engine sound. The reach area of the false engine sound emitted from the horn 4 according to the speed of the vehicle is shown in the broken line β in FIG. 1, and is approximately constant even when the speed is varied. The broken line β of FIG. 1 represents the reach area of the false engine sound with the sound pressure of 50 dB.

According to the first embodiment, the vehicle presence notification apparatus changes the frequency characteristics of the false engine sound according to the speed of the vehicle. The vehicle presence notification apparatus raises the ratio of the high-pitched frequency component rather than the low-pitched frequency component as the speed is raised.

The directivity of the false engine sound generated ahead from the vehicle can be narrowed according to the rise in the speed, similarly to the case of real engine vehicle. Thus, the false engine sound generated by the vehicle presence notification apparatus can be made similar to a real engine sound.

Because the vehicle presence notification apparatus changes the ratio of the frequency component so as to control the directivity of the false engine sound, many speakers are not necessary in the first embodiment. For this reason, the cost can be reduced and it becomes easy to mount the vehicle presence notification apparatus which can control the directivity of the false engine sound.

According to the first embodiment, the ratio of the high-pitched frequency component in the false engine sound is increased according to the rise in the speed. Therefore, a tone variation in the false engine sound can be made similar to a tone variation in the real engine sound in accordance with the rise in the speed.

That is, the false engine sound can be made similar to a real engine sound by controlling the tone variation and the directivity.

According to the first embodiment, the vehicle presence notification apparatus generates a non-directivity false engine sound downward from the vehicle in addition to controlling the directivity of the false engine sound emitted frontward from the vehicle.

A realistic engine sound is generated from the front grille 5 frontward from the vehicle by producing the false engine sound in which the directivity is controlled. A realistic engine sound is emitted downward from the engine compartment by producing the non-directivity false engine sound.

For this reason, the false engine sound emitted from the vehicle presence notification apparatus can be made similar to a real engine sound emitted from an actual engine vehicle.

### Second Embodiment

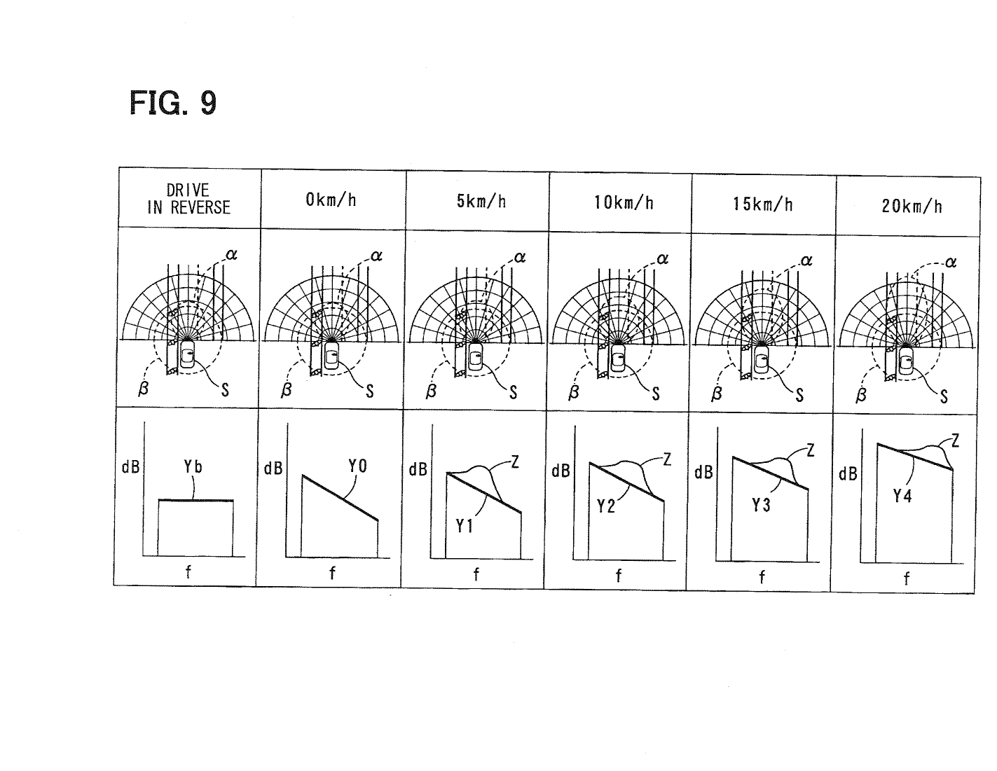

A second embodiment will be described with reference to FIG. 9, in which the same components as the first embodiment are indicated with the same reference codes.

As shown in FIG. 9, the directivity controller 3 of the second embodiment changes a sound-pressure emphasis region Z of the false engine sound from the low-pitched frequency component to the high-pitched frequency component according to the rise in the speed of the vehicle.

Thus, the sound-pressure emphasis region Z is changed from the low-pitched side to the high-pitched side according to the rise in the speed, thereby accurately controlling the directivity according to the rise in the speed.

Moreover, the tone variation in the false engine sound can be made more close to a tone variation in a real engine sound in accordance with the rise in the speed.

### Other Embodiments

In the above embodiments, the sound generator 32 directly changes the ratio of the high-pitched frequency component to the low-pitched frequency component. Alternatively, the frequency signal instructing the false engine sound generated by the sound generator 32 may be controlled using a parametric equalizer.

In the above embodiments, the ratio of the high-pitched frequency component to the low-pitched frequency component is changed by changing the frequency characteristics of the false engine sound. Alternatively, the ratio of the high-pitched frequency component to the low-pitched frequency component may be changed by adding a sound component. In this case, it is desirable to add plural sound components. Specifically, when the directivity is required to be narrowed, the plural sound components are mixed into the high-pitched side. When the directivity is required to be widened, the plural sound components are mixed into the low-pitched side.

The directivity speaker 1 is not limited to the parametric speaker. For example, the directivity speaker 1 may be made of a dynamic speaker such as cone speaker or piezoelectric speaker which generates an audible sound.

In the above embodiments, the opening of the swirl casing 16 faces downward under the vehicle. For example, the swirl casing 16 may be arranged to face frontward from the vehicle, and the false engine sound may be emitted frontward from the swirl casing 16. In this case, the directivity of the false engine sound emitted frontward from the vehicle through the swirl casing 16 is controlled.

In the above embodiments, the directivity speaker and the non-directivity speaker are used in the combination. However, the non-directivity speaker may be eliminated in the vehicle presence notification apparatus.

Such changes and modifications are to be understood as being within the scope of the present disclosure as defined by the appended claims.

What is claimed is:

1. A vehicle presence notification apparatus notifying a presence of a vehicle comprising:
a directivity speaker generating a false engine sound out of the vehicle;
a directivity controller controlling a directivity of the false engine sound based on a speed of the vehicle, wherein
the directivity controller controls a ratio of a high-pitched frequency component to a low-pitched frequency component in the false engine sound based on the speed of the vehicle.

2. The vehicle presence notification apparatus according to claim 1, wherein
the directivity controller increases the ratio of the high-pitched frequency component to the low-pitched frequency component in the false engine sound as the speed of the vehicle is raised.

3. The vehicle presence notification apparatus according to claim 1, wherein
the false engine sound has a sound-pressure emphasis region, and
the directivity controller changes the sound-pressure emphasis region from the low-pitched frequency component to the high-pitched frequency component as the speed of the vehicle is raised.
